(19) United States
(12) Patent Application Publication
(10) Pub. No.: US 2016/0318461 A1
(43) Pub. Date: Nov. 3, 2016

(54) Method Of Manufacturing A Cover Material For A Molded Part Of A Motor Vehicle And A Cover Material Of A Molded Part Of A Motor Vehicle

(71) Applicant: International Automotive Components Group GmbH, Dusseldorf (DE)

(72) Inventors: Helmut BERGERS, Grefrath (DE); Henk RIJPKEMA, Baarl (DE)

(21) Appl. No.: 15/140,210

(22) Filed: Apr. 27, 2016

(30) Foreign Application Priority Data
Apr. 28, 2015 (DE) 10 2015 106 485.5

(51) Int. Cl. B60R 13/02; B05D 7/24

(52) U.S. Cl. CPC B60R 13/02; B05D 7/24; B05D 2201/02; B05D 2503/00; B05D 2504/00; B05D 2507/00; B05D 2506/25

(57) ABSTRACT

This disclosure relates to a method of manufacturing a cover material for a molded part of a motor vehicle and to a respective cover material. The method includes the following: providing a cover skin which is provided with a seam or perforation and comprises a face and a back; and applying a back layer to the back of the cover skin, wherein, prior to applying the back layer, the seam or perforation is sealed on the back of the cover skin by applying a liquid, gelatinous or paste-like sealing material to the back of the cover skin above the seam or perforation.

### BACKGROUND

This disclosure relates to a method of manufacturing a cover material for a molded part or trim part of a motor vehicle and to a respective cover material. The cover material includes a cover skin made of plastic, which comprises a face and a back and is provided with a seam or perforation. A back layer is applied to the back of the cover skin. The cover skin may be a so-called slush skin, for example, made of a plastic powder such as PVC or a thermoplastic elastomer, e. g. based on urethane (e. g. PU or TPU), based on olefin (TPO) or based on polyester (TPEE). The cover skin may also be made of another material including leather or artificial leather, cloth or a combination thereof. The back layer applied to the back of the cover skin may be a foam layer, e. g. an open-cell or closed-cell foam, or an insulating layer, e. g. made of polyurethane, polyethylene or PVC.

Such cover materials are applied, for example, to interior trim components of motor vehicles, such as to door trims, instrument panels or other surfaces, to provide a visually and haptically appealing surface. During the manufacture of the cover material, the surface thereof may be patterned, e. g. provided with a surface texture.

In order to create an appealing impression of the cover material, it is also possible to provide the cover material with one or more seams, real seams being combinable with a seam-like patterning of the surface of the cover skin. Such seams may also be provided in the form of embroidery or an embroidery pattern. In addition, the cover skin, such as leather or artificial leather, may be provided with a perforation to create a high-grade impression. The seam or perforation produces holes extending through the cover skin.

When the back layer is applied, e. g. foamed-on, to the back of the cover skin, portions of the material of the back layer, e. g. of the foam, may penetrate through holes in the cover skin towards the face of the cover material. This may impair the quality of the cover material or even may render the cover material useless.

There is need for a method of manufacturing a cover material for a trim part of a motor vehicle and a respective cover material, the cover material comprising a seam, embroidery or perforation on its face without producing any quality problems.

### SUMMARY

According to one example, a cover skin is provided which comprises a face and a back and is provided with a seam or perforation. The seam may include arbitrarily extending single or multiple seam lines or embroidery or an embroidery pattern. All of this is referred to as seam in the following. The cover skin may be made of plastic and may be made as a so-called slush skin. A back layer is applied to the back of the cover skin. For example, a foam layer may be foamed-on to the back of the cover skin. The cover skin may also be in-mold decorated or in-press decorated. Before the back layer is applied, the seam or perforation on the back of the cover skin is sealed by applying a liquid, gelatinous or paste-like (also referred to as pasty) sealing material to the back of the cover skin above the seam or perforation. The sealing material may be applied to the back of the cover skin e. g. by brushing, rolling, roller application, spraying, printing, immersion or flooding and it seals the seam or perforation to prevent the back layer, e. g. a foam, from penetrating through the seam or perforation towards the face of the cover skin.

As the sealing material is not applied in the form of a strip, tape, film or in the form of a similar solid workpiece but in a liquid, gelatinous or paste-like form, it can cling to the back of the cover skin without forming any step or any noticeable step and can partially penetrate into the seam or perforation from the back of the cover skin and thus can provide a safe sealing thereof. After having been cured, the sealing material forms a sealing layer on the back of the cover skin, which forms a stepless junction with the back of the cover skin and is thus not perceivable from the face of the cover skin. In contrast to using a sealing tape or strip, there is no risk that the edges of the tape or strip become apparent on the face of the cover skin. Nevertheless, it is sufficient when the sealing material is applied in the region of the seam or perforation on the back of the cover skin. That is, the sealing material shall be applied only where it is needed.

When applying the sealing material to the back of the cover skin, it may have such a viscosity that it is easy to spread on the back of the cover skin and partially penetrates into the seam or perforation to seal it but does not penetrate through the seam or perforation towards the face of the cover skin. The viscosity values are dependent on the material and testing procedures as well as measurement conditions and the elongational viscosity may be within a range of e. g. 200 to 80,000 mPas (Pas: pascal second).

The sealing material can fully seal the seam or perforation without providing any additional sealing strip or sealing tape or another additional solid sealing material. Nevertheless, it is possible to embed into, or apply to, the sealing material an additional sealing strip, this sealing strip being impregnated with the sealing material. The sealing strip may be a woven-fabric, knit-fabric or non-woven or fleece ribbon, for example. Particularly in cases where the seam is provided in the region of a fake joint or thin area of the cover material, an additional sealing strip can counteract cracking or tearing when temperature variations, stresses and/or aging of the cover material occur.

It is possible to activate the sealing material before or after the back layer is applied, for example by heat treatment, pressure treatment, treatment with a gas, ultraviolet light, a liquid and/or with other components, with a catalyst or combinations thereof. It is also possible to cure the sealing material before or after the back layer is applied. To that end, the sealing material may be treated e. g. by heat, by irradiation with ultraviolet light or another light, by pressure, with a gas, a liquid and/or another component or combinations thereof.

The main function of the sealing material is to seal the seam or perforation. Additionally, it may improve the adhesion between the back of the cover skin and the back layer. It should be functionable at temperatures in the range of −35° C. to +120° C.

In one or more examples, the sealing material includes an adhesive. For example, physically setting adhesives and chemically curing adhesives may be used.

Physically setting adhesives are adhesives in which an adhesive ready for use, that is, the polymer itself is applied. To that end, a physical method is used, which first brings the adhesive into a workable form to resolidify it later. In the case of chemically curing adhesives, often also referred to as chemically reactive adhesives, the individual chemical building blocks of the adhesive are applied in the correct proportion. The solidification is achieved by chemically reacting the building blocks with each other. Adhesives may also be divided by other categories.

An example of physically setting adhesives which can be used as a sealing material is a solvent-containing wet adhesive. In a solvent-containing wet adhesive, a polymer is present in a dissolved state, in an organic solvent, and it is applied in this state. The adhesive is applied when sufficient solvent is still present in the adhesive layer, to ensure that the surface is wetted. Due to evaporation of the solvent, the adhesive sets, that is, it first thickens and finally solidifies due to physical interactions between the polymer chains. Solvents include but are not limited to, esters (e. g. ethyl acetate), ketones (e. g. 2-butanone) or tetrahydrofurane.

Further examples of sealing materials are dispersion adhesives. Dispersion adhesives normally use water as a mobile phase (dispersing agent) in which the ingredients of the adhesive (e. g. casein, thermoplastic or elastomeric polymer particles) are present as a dispersion. The water content is usually in the range of 40 to 70 percent by weight. After having been applied to the back of the cover skin, the dispersion breaks due to escape of the dispersing agent, due to its evaporation into the environment or due to a pH change. At the same time, the ingredients of the adhesive approach each other and form a film. By adding a curing agent (such as isocyanate), adhesion and cohesion can be improved.

Further examples of suitable sealing materials are plastisols. In the working form of plastisols, small solid polymer beads are dispersed in a liquid phase. After having been applied, the plastisol is gelated by heat supply. In this process, the polymer beads take up the liquid, e. g. a softening agent, swell and thus grow together to form a homogeneous layer. For a full curing after the gelation, heat at a higher temperature may be supplied once again. PVC plastisols, for example, can form flexible open- or closed-cell foams, wherein blowing agents, softening agents, and stabilizing agents can be added.

A contact adhesive may also be used as a sealing material. Contact adhesives (also referred to as power adhesives) may be both solvent adhesives and dispersion adhesives, which are processed by the contact bonding method. As binding agents for this type of adhesive, polymers (particularly polychloroprene and poylurethane) are used, which change from the amorphous to the crystalline state after a certain time has elapsed after the evaporation of the solvent, resulting in a strong increase in their strengths.

Examples of chemically curing adhesives which may be used as a sealing material include two-component adhesives (briefly: 2C adhesives). Basically, the reactive adhesives are divided into (at least) two-component and one-component systems.

In the case of two-component adhesives (briefly: 2C adhesives), two physically separated preparations are used, which include monomers, basic building blocks of the polymer formed in the reaction. One of the two preparations contains resin monomers (or binding agents) while the other one contains curing agents. As further ingredients of the preparations, stabilizing agents, thixotroping agents, accelerating agents, other additives as well as fillers may be used. The two components are mixed in the correct proportion prior to application. The chemical reaction of the adhesive polymer begins with the contact of resin and adhesive polymer. Due to the progressing reaction, the viscosity of the mixture increases steadily. The application of the sealing material is followed by a curing time in which the final strength of the sealing layer builds up. This curing time is also affected by ambient influences, particularly by temperature. An increase of temperature results in accelerated curing and often also in an increased strength while lower temperatures prolong the curing time.

One-component adhesives (briefly: 1C adhesives) may also be used as a sealing material. In this case, the adhesive ready for use is directly applied to the back of the cover skin. The adhesive then cures due to a change in the ambient conditions such as increase in temperature, admission of air humidity, exclusion of atmospheric oxygen or contact with the substrate surface. Also in the case of chemically curing one-component adhesives, chemical reactions between resin monomers and curing agents are responsible for the structure of the polymer.

A special example is a methyl methacrylate adhesive. Methyl methacrylate adhesives are two-component reactive adhesives in which the monomer (the methyl ester of methylacrylic acid) used is polymerized by a free-radical chain reaction. To initiate the polymerization reaction, a reactive radical may be needed, which is formed from e. g. a peroxide if an accelerating agent is added thereto. By mixing the two components, the free-radical chain reaction is initiated and the adhesive cures. Methyl methacrylate (MMA) adhesive has the following properties: high strength (up to 25 N/mm²); in the case of 10:1-MMA adhesives, additionally a high elasticity (up to 120% elongation); fast curing (touchable after 5 to 120 minutes). MMAs are UV-resistant, resistant to chemicals and water-resistant and are suited for operating temperatures of −40° C. to +120° C.

Radiation-curing adhesives may also be used as a sealing material. These 1C adhesives cure to form solid polymers due to free-radical polymerization, the formation of the initiation radicals being initiated by irradiation with UV light (or other radiation sources such as electrons). In this case, the wave lengths of the UV light emitted by the radiation source have to coincide with the absorption wave lengths of the initiator used. This group of adhesives is also referred to as UV adhesives or UV acrylates. A specific example includes urethane acrylate resins, which include monomers as appropriate. In the liquid state, such a radically curing UV adhesive is mainly made of monomers and photoinitiators. In this low-viscosity state, the adhesive is easy to dose. Due to the action of UV radiation, the photoinitiators are cleaved to free radicals (homolytic cleavage), or they absorb hydrogen atoms from hydrocarbons and thus produce radicals. These radicals initiate the formation of polymer chains. In the cured state, the UV adhesive is made up of cross-linked or thermoplastic polymer chains, depending on the functionality of the monomers used. Acrylates react through free-radical polymerization, which is susceptible to oxygen. The reaction should therefore be performed either through the use of transparent substrates to the exclusion of oxygen or through the use of an inert atmosphere.

Further examples of sealing materials are cationic epoxy adhesives. In contrast to the radically curing acrylate adhesives, the cationic adhesive systems can further cure even in a dark environment after they have been sufficiently activated by UV radiation. In addition, they are not inhibited by oxygen.

Further examples of sealing materials are epoxide resin adhesives. Epoxide resin adhesives (briefly: epoxy adhesives) are made up of the two components resin and curing agent. As the epoxy resin, polymer building blocks are used which have so-called epoxide rings at the end. To that end, reaction products of bisphenol A and epichlorohydrin, for example, are used, which form a stable thermosetting resin after they have been mixed with the curing agent including amino or mercapto groups. The curing reaction may be performed at both room temperature and elevated temperature. In the latter case, a higher strength of the adhesive-bonded joint is usually achieved. The cured adhesive has a very high strength.

Further examples of sealing materials are polyurethane (PUR) adhesives. Polyurethane adhesives are one- or two-component adhesives which can cure by polyaddition. The one-component PUR adhesives cure while supplying air humidity and/or heat. It is possible to combine both curing mechanisms so that a first handling strength is achieved by the air-humidity curing process while the final strength is not achieved until heat has been applied. A special form of polyurethane adhesives includes reactive hot-melt adhesives, which are heated, like the normal (non-reactive) hot-melt adhesives, prior to processing but later chemically cross-link by reacting with water molecules.

The sealing material may be applied in the form of a liquid, a gel or a paste, which are flowable or at least spreadable. The elongational viscosity of the sealing material during application may be within a range of e. g. 200 to 80,000 mPas, depending on the material and the testing procedures as well as the measurement conditions.

The sealing material may also include a foamed plastic or a foamable material which is applied in the form of a layer to the back of the cover skin, e. g. a PU-based foam or a plastisol including a foaming agent.

The sealing material may be treated immediately before it is applied, or after it has been applied, to the back of the cover skin so that it cures, but it can also remain flexible after the application and, if required, after a treatment. A treatment before the application includes e. g. the activation of a 2C sealant. It may also be provided that the sealing material does not finally cure until the back layer has also been applied.

### SHORT DESCRIPTION OF DRAWINGS

Examples will now be explained in greater detail with reference to the accompanying drawings.

FIG. 1 shows an example of a molded part including a cover material.

FIG. 2 shows a further example of a molded part including a cover material.

### DESCRIPTION OF EXAMPLES

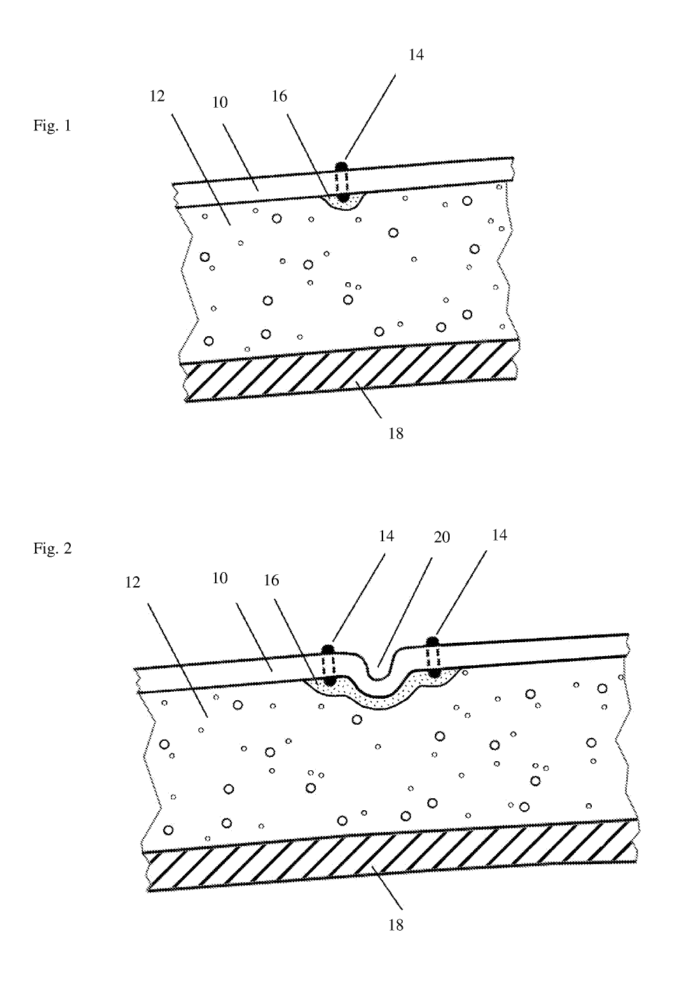

FIG. 1 shows a molded part, which may be used as an interior trim component of a motor vehicle, e. g. for an instrument panel, a door trim or another component. The molded part includes a cover skin 10 and a back layer 12, which are applied to a substrate 18. The cover skin 10 may be, for example, a slush skin or a film but also an artificial leather or a natural leather. Slush skins are made of a plastic powder, e. g. by rotational sintering. The slush skin 10 may be made of polyvinyl chloride (PVC), thermoplastic elastomer polyolefin (TPO), polyurethane (PUR), thermoplastic polyurethane (TPU) or thermoplastic elastomer (TPE), for example, or may include these materials. It may also be made of cloth, leather or artificial leather.

The back layer 12 may be a closed-cell or open-cell foam layer, e. g. of TPO, PVC, urethane, polypropylene (PP), polycarbonate (PC), acrylonitrile butadiene styrene (ABS), PC-ABS, styrene maleic anydride (SMA), polyphenylene oxide (PPO) and TPE. It may be applied to the back of the cover skin 10 by back foaming, back injection or press-forming, to mention only a few examples.

The substrate 18 may form a structural component of the interior trim component of the motor vehicle and is made of PP, polyethylene (PE), ABS, TPE, PC-ABS, SMA, PPO, TPO or nylon, for example. The substrate 18 may also be made of a material containing man-made or natural fibers. It may be made by injection molding or press molding.

The cover skin 10 and the back layer 12 together form a cover material, wherein the substrate 18 may be molded to the cover material or may be connected thereto by laminating or other methods.

In the example shown, a seam 14 is inserted into the cover skin 10, this seam penetrating through the cover skin 10 and thus forming a perforation in the cover skin 10. In other examples, a perforation without a seam may also be formed in the cover skin 10. The seam may be formed by a thread of man-made or natural fibers.

In order to prevent the material of the back layer 12 forming the seam 14 from penetrating through the perforation holes towards the face of the cover skin 10, the seam on the back of the cover skin 10 is sealed by a sealing material 16. As was mentioned above, this sealing material may include an adhesive, all of the above-mentioned examples being applicable, for example a sealing material in the form of a plastisol such as a PVC plastisol, a two-component material, a foamed plastic, etc. The sealing material may be applied in a liquid form, as a gel or a paste. It may be applied to the back of the cover skin 10 by brushing, rolling, roller application, spraying, printing, immersion or flooding, for example. After it has been applied, it may be activated and/or cured, for example by heat treatment, pressure treatment, treatment with a gas, a liquid and/or with another component, with a catalyst or combinations thereof. Irradiation with UV light or another electromagnetic radiation to cure and/or cause the sealing material to react to the end is also conceivable. In this case, the sealing material 16 may partially or fully cure and/or react before, during or after the application of the back layer 12. Even after the sealing material has been cured and/or caused to react completely, it may maintain a certain amount of flexibility. In this case, the sealing material, after it has been fully cross-linked, has no really “hard”, thermosetting behavior such as for example a cured structural adhesive, but it has the behavior of an elastomer, that is, it is virtually “rubber-like” and is permanently flexible.

As is shown in FIG. 1, the sealing material 16 is applied where it is needed. It may form on its edges a stepless junction with the back surface of the cover skin 10 and thus may unperceivable at front face of the cover material 10.

FIG. 2 shows a further example of a molded part, similar components being denoted by the same reference symbols and being not described again. Reference is made to the above description relating to FIG. 1. In the example of FIG. 2, a fold 20 is formed in the cover material 10, which is hemmed by a seam 14 on both sides to create the impression of a seam which joins two portions of the cover skin 10. FIG. 2 is a schematic view which is greatly enlarged. Indeed, the fold 20 may be closed to create the impression of two adjacent cover skin portions which are then joined by the seams 14. This is also referred to as a fake joint. As in FIG. 1, the back of the cover skin 10 is coated with the sealing material 16 to seal the perforations formed by the seams 14. Otherwise, what was said above applies.

In the liquid sealing material applied to the back of the cover skin, an additional reinforcing layer may be inserted, or a reinforcing layer may be placed on the sealing material, the reinforcing layer being impregnated with the sealing material. The reinforcing layer may be formed of a woven fabric, knit fabric or non-woven material or fleece, for example, and causes a reinforcement and/or stiffening of the seam region. This is of use particularly when a joint or a thin area in the cover skin is present in the region of the seam so that the risk of breaking or tearing is particularly high when temperature variations, stresses, and aging of the cover material occur. However, such an additional reinforcing layer may be omitted.

What is claimed is:

1. A method of manufacturing a cover material for a molded part of a motor vehicle, comprising:
providing a cover skin which is provided with a seam or perforation and comprises a face and a back; and
applying a back layer to the back of the cover skin,
wherein, prior to applying the back layer, the seam or perforation is sealed on the back of the cover skin by applying a liquid, gelatinous or paste-like sealing material to the back of the cover skin over the seam or perforation.

2. The method of claim 1, wherein the sealing material is applied by brushing, rolling, roller application, spraying, printing, immersion or flooding.

3. The method of claim 1, wherein the sealing material is at least one of an activated and cured sealing material before the back layer is applied.

4. The method of claim 3, wherein the sealing material is activated by heat treatment, pressure treatment, treatment with a gas, a liquid and/or another component, a catalyst or combinations thereof.

5. (canceled)

6. The method of claim 3, wherein the sealing material is cured by heat treatment, irradiation with ultraviolet light, pressure treatment, treatment with a gas, a liquid and/or another component or combinations thereof.

7. The method of claim 1, wherein the sealing material includes an adhesive.

8. The method of claim 7, wherein the adhesive is selected from the group consisting of methyl methacrylate adhesives, radiation-curing adhesives, cationic epoxy adhesives, epoxide resin adhesives, polyurethane adhesives, solvent-type adhesives, dispersion adhesives, contact adhesives, two-component adhesives, and combinations thereof.

9. The method of claim 1, wherein the sealing material includes at least one of:
a plastisol;
a gel or a paste;
a foamed plastic or a foamable material; and
a two-component material.

10. (canceled)

11. (canceled)

12. (canceled)

13. The method of claim 1, wherein the cover skin is a slush skin.

14. The method of claim 1, wherein the back layer is applied by back foaming, back injection or pressure forming.

15. The method of claim 1, wherein the sealing material remains flexible after it has been applied.

16. A cover material of a molded part for a motor vehicle, comprising:
a cover skin which is provided with a seam or perforation and comprises a face and a back; and
a back layer on the back of the cover skin, wherein
between the back layer and the cover skin in the region of the seam or perforation, a sealing material is applied to the back of the cover skin, which has a liquid, gelatinous or paste-like initial state and forms a flexible layer.

17. The cover material of claim 16, wherein the sealing material includes an adhesive.

18. The cover material of claim 17, wherein the adhesive is selected from the group consisting of methyl methacrylate adhesives, radiation-curing adhesives, cationic epoxy adhesives, epoxide resin adhesives, polyurethane adhesives, solvent-type adhesives, dispersion adhesives, contact adhesives, two-component adhesives, and combinations thereof.

19. The cover material of claim 16, wherein the sealing material includes at least one of:
a plastisol;
a gel or a paste;
a foamed plastic or a foamable material; and
a two-compartment material.

20. (canceled)

21. (canceled)

22. (canceled)

23. The cover material of claims 16, wherein the cover skin is a slush skin.

24. The cover material of claim 16, wherein the back layer includes a foamed layer.

25. The cover material of claim 16, wherein, in the region of the seam or perforation between the cover skin and the back layer, an additional sealing material made of a solid material comprising one of a knitted fabric, woven fabric, non-woven or fleece material or a film is inserted, the additional sealing material being impregnated with the liquid, gelatinous or paste-like sealing material.

26. The cover material of claim 16,
wherein, in the region of the seam or perforation between the cover skin and the back layer, no additional sealing material made of a solid material is inserted.

27. A trim part for a motor vehicle, the trim part including:
a substrate and a cover skin provided over the substrate;
the cover skin including a seam or perforation and comprising a face and a back;
the trim part further including:
a back layer on the back of the cover skin, the back layer being sandwiched between the substrate and the cover skin;
wherein between the back layer and the cover skin in the region of the seam or perforation, a sealing material is applied to the back of the cover skin, which has a liquid, gelatinous or paste-like initial state and forms a flexible layer.
